(19) United States
(12) Patent Application Publication
(10) Pub. No.: US 2015/0264656 A1
(43) Pub. Date: Sep. 17, 2015

(54) AUTOMATIC TRANSMIT POWER CONTROL IN LOS MIMO NXN CONFIGURATION FOR WIRELESS APPLICATIONS

(71) Applicant: Telefonaktiebolaget L M Ericsson (publ), Stockholm (SE)

(72) Inventors: Antonio Carugati, Lissone (IT); Giovanni Milotta, Busto Arsizio (IT)

(73) Assignee: Telefonaktiebolaget L M Ericsson (publ), Stockholm (SE)

(21) Appl. No.: 14/426,263

(22) PCT Filed: Sep. 5, 2012
(86) PCT No.: PCT/EP2012/067303

§ 371 Date: Mar. 5, 2015

(51) Int. Cl. H04W 52/42; H04L 27/02; H04B 7/04

(52) U.S. Cl. CPC H04W 52/42; H04B 7/0426; H04L 27/02

(57) ABSTRACT

The present invention relates to a method of automatic transmit power control (ATPC) in a N×N Multiple-Input Multiple-Output (MIMO) radio communication system. The ATPC method comprises estimating a received power of each radio, determining a propagation matrix comprising each radio path's attenuation between the transmitter radio unit and the receiver radio unit, determining total power corrections using the received power, the propagation matrix and a target receiver power, and applying the total power corrections to the transmitter radio units. The determining of the total power corrections further comprises determining an interference level at each receiver radio unit based on the received power and the propagation matrix, determining a power variation for the radio unit using the interference levels, and determining a power correction using the received power, the target receiver power and the propagation matrix. The power correction is applied to the transmitter radio units.

### TECHNICAL FIELD

The invention relates in general to an automatic transmit power control method and system for radio equipment, and more particularly to an automatic transmit power control method and system in a line-of-sight multiple-input multiple-output wireless communication system.

### BACKGROUND

Today, more than ever, wireless network operators are looking for ways to increase the efficiency, traffic capability and robustness of their radio communication systems. A well-known way of providing efficiency, in terms of capacity per Hertz of bandwidth used, is to employ a Multiple-Input Multiple-Output (MIMO) communication system.

Unfortunately, applying advanced techniques such as MIMO technology in existing Single-Input Single-Output (SISO) communication system is not a simple task, and will often lead to new design challenges. For instance, when employing MIMO in a Line-Of-Sight (LOS) microwave communication link, traditional Automatic Transmit Power Control (ATPC) techniques used for combating fading in SISO communication systems cannot be used.

In a SISO communication systems ATPC is a crucial function used to automatically adjust the transmit power, based on the Receiver Signal Strength Indicator (RSSI) level measured by the receiving radio unit, in order to maintain the receiver input level at the far-end terminal at a target value when the communication system is subjected to fading. The receiver input level is compared with the target value, a deviation is calculated and sent to the near-end terminal to be used for possible adjustment of the transmit power. However, to base the ATPC in a MIMO communication system only on the measured RSSI values is not suitable because it is not possible to distinguish the power contributions of the single transmitter power from the transmitting radio unit to that of the total receiver RF power which also comprises the power contribution from multiple interfering RF signals. Moreover, the ATPC algorithm for a SISO radio communication link isn't usable in a MIMO radio communication link because it only handles one radio path without taking the whole system into consideration. Adjusting the transmit power of only one radio path in a ‘blind mode’ fashion is not an option since it will corrupt the sensitive relationship between the main signal paths and the interference paths, probably resulting in that the availability of the radio link goes down and even, in some cases, converge in a condition whereby the system could not automatically recover from on its own.

Thus, finding a way to allow for an effective ATPC in a LOS MIMO communication system is therefore highly sought after.

### SUMMARY OF THE INVENTION

With the above description in mind, then, an aspect of the present invention is to provide a way to allow for an effective ATPC in a LOS MIMO communication system that will mitigate, alleviate, or eliminate one or more of the above-identified deficiencies in the art and disadvantages singly or in any combination.

A first aspect of the present invention relates to a method of automatic transmit power control in a multiple-input multiple-output radio communication system having N transmitter radio units, T₁, T₂, . . . Tₙ, and N receiver radio units, R₁, R₂, . . . Rₙ, the method comprising estimating a received power, P₁^{RX}, P₂^{RX}, . . . Pₙ^{RX}, of each radio unit R₁, R₂, . . . Rₙ, determining a propagation matrix comprising each radio path's attenuation between said transmitter radio unit and said receiver radio unit, determining total power corrections ΔPₜₒₜᵢ^{TX} using said received power, said propagation matrix and a target received power, PW_{TG}, applying said total power corrections to said Tᵢ transmitter radio units, characterized in that said determining of said total power corrections comprising, determining an interference level at each receiver radio unit based on said received power at each radio unit and said propagation matrix, determining a power variation ΔPᵢₘₐₓ^{TX} for the Tᵢₘₐₓ radio unit using said interference levels, determining a max total power correction ΔPₜₒₜᵢₘₐₓ^{TX} using said received power, said target receive power, said propagation matrix and said power variation, and wherein said applying further comprising applying said max total power correction to the Tᵢₘₐₓ transmitter radio unit.

The method wherein the total power corrections for each radio transmitter unit (except the one corresponding to the lower interference level), ΔPₜₒₜᵢ^{TX} may further be determined according to

ΔPₜₒₜᵢ^{TX}|_{∀i={1 . . . N}≠imax}=max|PW_{TG}−Pₙ^{TX}·Gₙₙ|_{∀n={1N}}.

The method wherein target received power may be preset.

The method wherein power variation may be determined according to

$$Δ {P}_{i ma x}^{TX} = \frac{\begin{matrix}{min [ {C}_{i ma x} / {I}_{n} ]}_{∀ n = \{ 1 … N \} \neq i ma x} + \\ {min [ {C}_{j} / {I}_{i ma x} ]}_{∀ j = \{ 1 … N \} \neq i max}\end{matrix}}{2}$$

$$wherein {C}_{i max} / {I}_{j max}$$

is the path with the lowest interference value.

The method wherein said power correction for the radio transmit unit corresponding to the path with the lowest interference value ΔPₜₒₜᵢₘₐₓ^{TX} may be determined according to ΔPₜₒₜᵢₘₐₓ^{TX}=max|PW_{TG}−Pₙ^{TX}·Gₙₙ|_{∀n={1 . . . N}}+ΔPᵢₘₐₓ^{TX}.

A second aspect of the present invention relates to a system for automatic transmit power control in a multiple-input multiple-output radio communication system having N transmitter radio units T₁, T₂, . . . Tₙ, and N receiver radio units, R₁, R₂, . . . Rₙ, the system comprising R₁, R₂, . . . Rₙ radio units each adapted for estimating a received power, P₁^{RX}, P₂^{RX}, . . . Pₙ^{RX}, at least a modem adapted for determining a propagation matrix comprising each radio path's attenuation between said transmitter radio unit and said receiver radio unit, said at least a modem is further adapted to determining total power corrections ΔPₜₒₜᵢ^{TX} using said received power, said propagation matrix and a target received power, PW_{TG}, wherein said transmitter radio units are adapted to receive said total power corrections and applying said total power corrections to said Tᵢ transmitter radio units, characterized in that said at least a modem is further adapted to determining an interference level at each receiver radio unit based on said received power at each radio unit and said propagation matrix, determining a power variation ΔPᵢₘₐₓ^{TX} for the Tᵢₘₐₓ transmitter radio unit using said interference levels, determining a max total power correction ΔPₜₒₜᵢₘₐₓ^{TX} using said received power, said target receive power, said propagation matrix and said power variation, and wherein the Tᵢₘₐₓ transmitter radio unit is further adapted to receive and applying said max total power correction.

The system wherein said at least a modem may be adapted to determine the total power corrections to apply to the radio transmitter units (except the one corresponding to the lowest interference level) ΔPₜₒₜᵢ^{TX} are determined according to

ΔPₜₒₜᵢ^{TX}|_{∀i={1 . . . N}≠imax}=max|PW_{TG}−Pₙ^{TX}·Gₙₙ|_{∀n={1 . . . N}}.

The system wherein target received power may be preset in said at least a modem.

The system wherein said at least a modem may be further adapted to determine the power variation is according to

$$Δ {P}_{i ma x}^{TX} = \frac{\begin{matrix}{min [ {C}_{i ma x} / {I}_{n} ]}_{∀ n = \{ 1 … N \} \neq i ma x} + \\ {min [ {C}_{j} / {I}_{i ma x} ]}_{∀ j = \{ 1 … N \} \neq i ma x}\end{matrix}}{2}$$

wherein Cᵢₘₐₓ/Iⱼₘₐₓ is the path with the lowest interference value.

The system wherein said at least a modem may be further adapted to determine the max total power correction to apply to the radio transmit unit corresponding to the path with the lowest interference value ΔPₜₒₜᵢₘₐₓ^{TX} according to ΔPₜₒₜᵢₘₐₓ^{TX}=max|PW_{TG}−Pₙ^{TX}·Gₙₙ|_{∀n={1 . . . N}}+ΔPᵢₘₐₓ^{TX}.

The system wherein said multiple-input multiple-output radio communication system may be a microwave radio link system employing quadrature amplitude modulation in a line-of-sight configuration.

The variations within each aspect disclosed above may be combined in any way possible to form different embodiments of the present invention.

### BRIEF DESCRIPTION OF THE DRAWINGS

Further objects, features, and advantages of the present invention will appear from the following detailed description of some embodiments of the invention, wherein some embodiments of the invention will be described in more detail with reference to the accompanying drawings, in which:

FIG. 1 shows a block diagram of a 2×2 LOS MIMO communication system, according to an embodiment of the present invention;

FIG. 2 shows a block diagram of a 2×2 LOS MIMO communication system employing a MIMO ATPC loop;

FIG. 3 shows a flowchart describing the 2×2 MIMO ATPC method according to an embodiment of the present invention;

FIG. 4 shows a block diagram of a N×N LOS MIMO communication system, according to an embodiment of the present invention; and

FIG. 5 shows a flowchart describing the N×N MIMO ATPC method according to an embodiment of the present invention.

### DETAILED DESCRIPTION

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference signs refer to like elements throughout the application.

Embodiments of the present invention will be exemplified by a microwave radio link based on QAM modulation in a Line-Of-Sight (LOS) Multiple-Input Multiple-Output (MIMO) configuration. The present invention allows for a simple but effective Automatic Transmit Power Control (ATPC) of said LOS MIMO configuration (hereinafter referred to as MIMO ATPC) in a microwave radio link system. The basic concept of the present invention is to take advantage of information coming from the MIMO canceller algorithms of each receiver modem together with the RSSI levels in the receiver radios, to establish a control link from the receivers to the transmitters, and thereby controlling the power of the transmitters. The transmit power of each transmit radio is simultaneously controlled in order, for instance, to increase the transmit power when a drop in the received signal level of either receiver radio is detected. Thus, an ATPC loop in the LOS MIMO system can be established and simultaneously control the interference and main amplitude of the receiver signals to optimize the MIMO canceller algorithm.

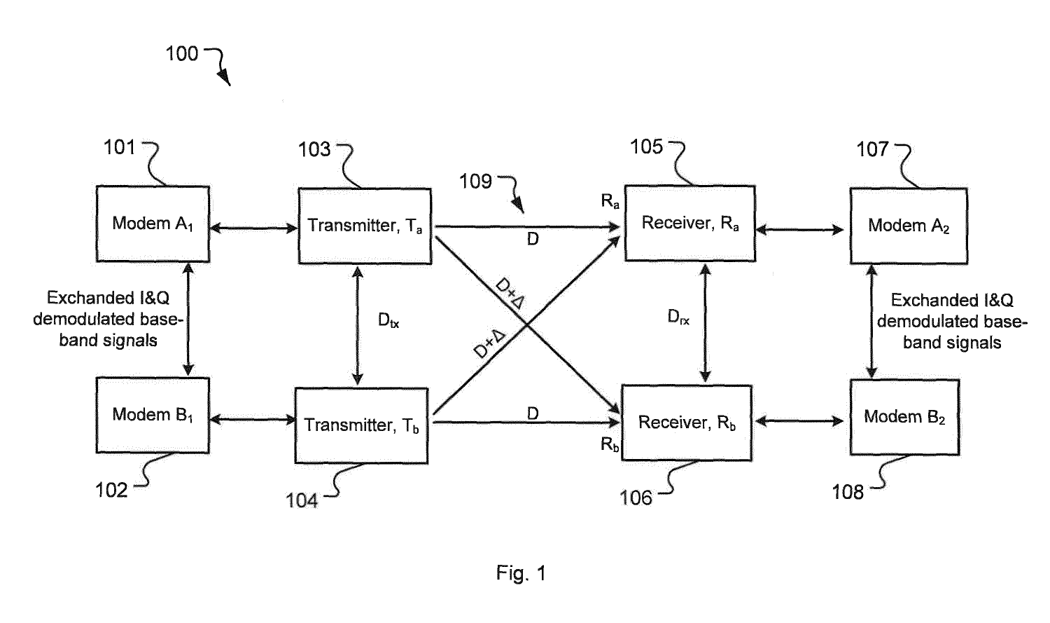

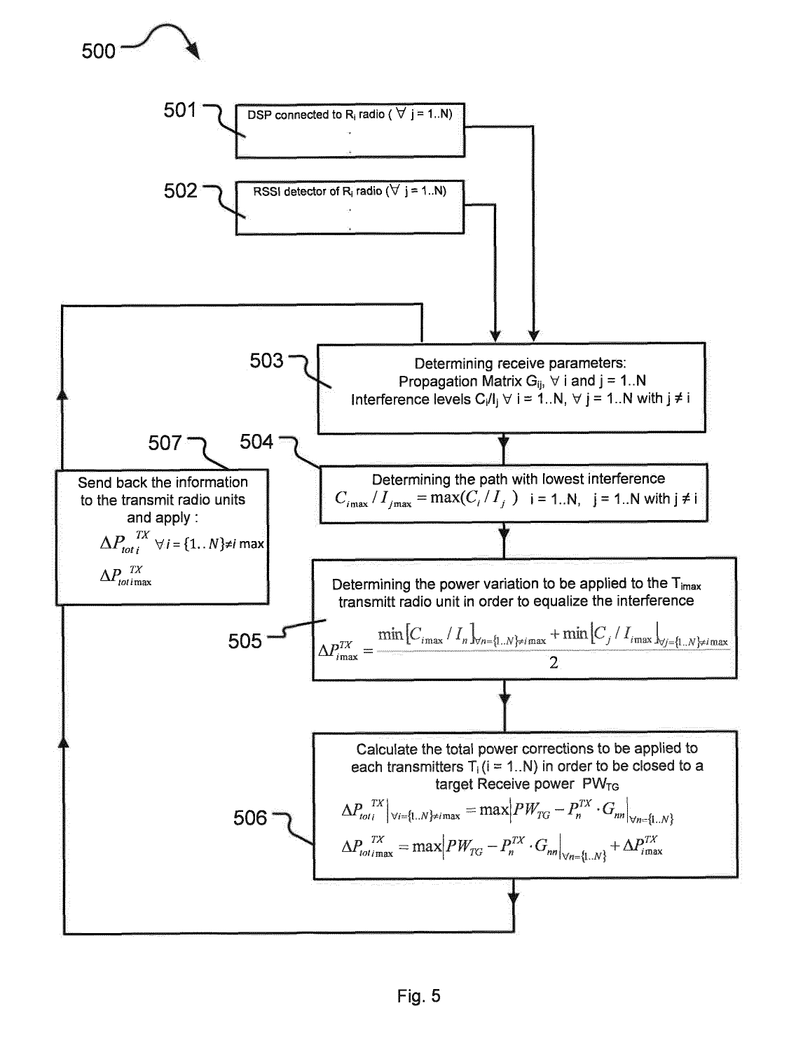

The present invention will now be described in more detailed using a 2-by-2 (hereinafter written as 2×2) LOS MIMO communication system 100, as shown in FIG. 1, as an example of an embodiment of the present invention. However, the underlying principle of the invention may be generalized to the LOS MIMO N-by-N case as shown in FIG. 5.

Two transmitter radios, Tₐ 103 and T_{b} 104, and two receiver radios, Rₐ 105 and R_{b} 106 are each connected to a modem 101, 102, 107, 108 as shown in FIG. 1. The spatial differential between the transmitters 103, 104, Dₜₓ, and receivers 105, 106, Dᵣₓ, is determined such to obtain a quadrature relationship between interfering signals, D+Δ, and the main path signals, D 109. Thus, the distances Dₜₓ, Dᵣₓ and D are chosen in order to comply with the equation Dₜₓ*Dᵣₓ=D*(λ/2), where λ is referring to the radio carrier wavelength.

The modulation and demodulation functions are performed by the four modems A₁ 101, A₂ 107, B₁ 102, and B₂ 108, two for each side of the hop 109, and the RF up/down frequency conversions are performed by the four radio units (Tₐ, T_{b}, Rₐ and R_{b}) 103, 104, 105, 106. Each receiver block of the radio units comprise a Received Signal Strength Indication (RSSI) detector that supplies an estimation of the received RF power lever detected in the radio unit. The determined RSSI data in the receivers 105, 106 is sent to a digital control block in the receiver modems 107, 108 which uses the information to adjust the transmit power in the transmitter units 103, 104 using a control communication channel over the hop 109.

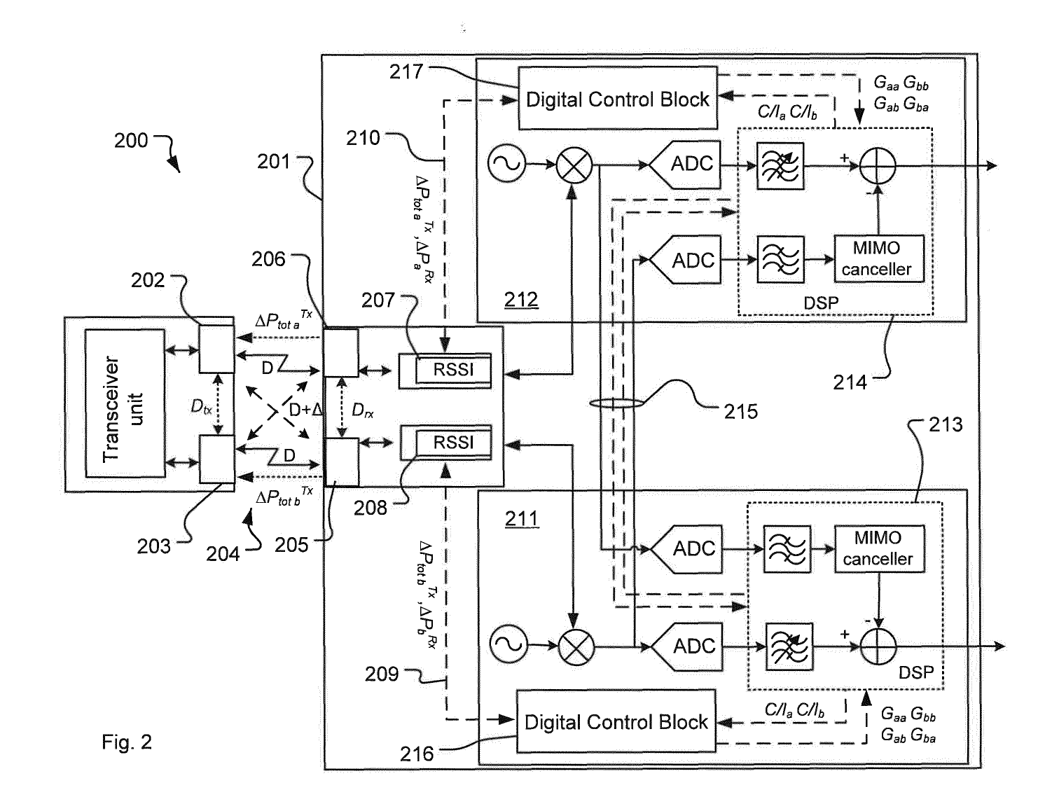

The basic functionality of the interference canceller, or MIMO canceller, is performed by a DSP 213, 214 in each modem unit 107, 108. DSP algorithms running in the DSPs 213, 214 recover the signal coming from the radio units 105, 106, cancels the residual interference, and forward the data stream typically to a traffic manager block. A typical implementation of LOS MIMO architecture is based on an exchange of the I&Q demodulated base-band analog signal for performing the interference cancellation. Each DSP, one per modem 107, 108, performing the interference cancellation is capable of supplying, in real-time, data regarding the electrical phase difference and amplitude ratio between the main paths (D) and interference paths (D+Δ) in the hop 109. If this information is shared between the two modems 107, 108, it can be used to calculate a radio link propagation matrix. The exchange of data between the two modems 107, 108 can be carried out, for instance, using separate digital channel communication as described in detail in the International Application no PCT/EP2009/053754 (30 Mar. 2009) entitled ‘Communication between modem in XPIC configuration for wireless applications’ which hereby is in its entire incorporated by reference. The international application disclose a novel way of exchanging data in real-time between two modems in an XPIC configuration. A similar real-time communication channel 215 between the modems 211, 212 in a LOS MIMO communication system 200 as shown in FIG. 2, can be used to exchange data needed for performing the MIMO ATPC according to an embodiment of the present invention. The output power transmitted by the radios Tₐ and T_{b} 202, 203 are denoted Pₐ^{TX} and P_{b}^{TX}, and the total received power at the antennas of the receiving radios 205, 206 Rₐ and R_{b} (these values are also detected and handled by the RSSI circuitry 207, 208 in the radios) are denoted Pₐ^{RX} and P_{b}^{RX}. The attenuation of the radio paths calculated in the digital control blocks 216, 217 are denoted Gₐₐ, G_{bb}, G_{ab} and G_{ba}. The total received powers, Pₐ^{RX} and P_{b}^{RX}, in the received radio 205, 206 may then be expressed as shown in equation (1).

Pₐ^{RX}=Pₐ^{TX}·Gₐₐ+P_{b}^{TX}·G_{ab}

P_{b}^{RX}=P_{b}^{TX}·G_{bb}+Pₐ^{TX}·G_{ba} (1)

In the same way the interference level signal can be expressed as the relationship between the amplitude of the main signal path and the amplitude of the radio path of the concurrent radio path as shown in equation (2).

$$C / {I}_{a} = 10 \cdot LOG ( \frac{{P}_{a}^{TX} \cdot {G}_{aa}}{{P}_{b}^{TX} \cdot {G}_{ab }} ) \\ C / {I}_{b} = 10 \cdot LOG ( \frac{{P}_{b}^{TX} \cdot {G}_{bb}}{{P}_{a}^{TX} \cdot {G}_{ba}} ) \qquad ( 2 )$$

In following, the interference C/I values, unless differently specified, are expressed in dB.

In the same way as in the SISO ATPC, it's possible to define a (or have it preset) target received power, PW_{TG}, of the system. PW_{TG} is thus the target receive power wanted at the receiver side and it represents the power level wanted at the receiver antennas just across the main path, D, over the hop 204 without any interference. For instance, considering the path Tₐ→Rₐ over the hop 204, then the PW_{TG} is the target receive power at the Tₐ transmitter only, without the contribution from T_{B}. Looking at the relationship (1), PW_{TG} is then the whished target receive power of the terms Pₐ^{TX}·Gₐₐ at receiver Rₐ and P_{b}^{TX}·G_{bb} at receiver R_{b}.

All the magnitudes described above are known and handled by the digital control blocks 216, 217 in respective modems 211, 212, and can be employed in the MIMO ATPC.

The basic concept of the MIMO ATPC loop is to perform a variation of the transmit power of the two radios Tₐ and T_{b}, in order to reach the best trade-off between optimum interference levels of the LOS MIMO communication system while still ensuring a minimum target receive power at the receivers. The MIMO ATPC method according to the present invention balances the interference values of the two radio paths, D, over the hop 204 and simultaneously converging at the wanted receiver target receive power. If the interference levels at the receiver side, C/Iₐ and C/I_{b}, are known the MIMO ATPC method will determine the needed adjustments of the transmit radio units 202, 203 power in order to balance and optimize the interference ratio values. The MIMO ATPC will also drive the system to work in a symmetrical way with the two interference ratio values equal to each other. The ‘interference balance’ operation is performed by estimating each transmit power correction value and apply it (in the DSP units 213, 214) only to the radio unit corresponding to the radio path corrupted by higher interference. The estimated power correction value is calculated such that an average interference level, in both radio paths, is reached. The transmit power variation is obtained by the equations in (3).

$$C / {I}_{avrage} = \frac{( C / {I}_{a} + C / {I}_{b} )}{2} \\ \{ \begin{matrix}Δ {P}_{a}^{TX} = C / {I}_{a} - C / {I}_{average} if C / {I}_{a} > C / {I}_{b} \\ Δ {P}_{b}^{TX} = 0\end{matrix} \\ or \\ \{ \begin{matrix}Δ {P}_{a}^{TX} = 0 \\ Δ {P}_{b}^{TX} = C / {I}_{b} - C / {I}_{average} if C / {I}_{b} > C / {I}_{a}\end{matrix} \qquad ( 3 )$$

The ‘interference balance’ operation will be better understood, by looking at equation (2). In fact, to perform an equalization of the interference signals it is enough to increase the transmit power of the higher interfered path by a ΔPₐ^{TX} or ΔP_{b}^{TX} amount. Consequently, whereas the higher interfered path decrease its C/I values the other, instead, increase its C/I value reaching together an equal value at an average point (see equation (2)).

After estimating the adjustment power for equalizing the interference level, it is applied to bring the communication system close to a target receiver power level, PW_{TG}. The target receiver power level may be preset in the LOS MIMO communication system or determined by the DSPs. The proposed MIMO ATPC method increases the power of the two transmit radio units by an equal amount such that the most degraded link can reach the nominal received power value. Thus the interference ratios C/Iₐ and C/I_{b} are maintained constant, improving the reliability and availability of the link, and, at the same time, increases the robustness of the communication system in terms of signal to noise ratio. The power corrections ΔPₜₒₜₐ^{TX} and ΔP_{totb}^{TX} applied to the transmit radio units 202, 203 can thus be expressed as shown in equation (4).

ΔPₜₒₜₐ^{TX}=max((PW_{TG}−Pₐ^{TX}·Gₐₐ−ΔPₐ^{TX});(PW_{TG}−P_{b}^{TX}·G_{bb}−ΔP_{b}^{TX}))

ΔP_{totb}^{TX}=max((PW_{TG}−Pₐ^{TX}·Gₐₐ−ΔPₐ^{TX});(PW_{TG}−P_{b}^{TX}·G_{bb}−ΔP_{b}^{TX})) (4)

The terms Pₐ^{TX}·Gₐₐ and P_{b}^{TX}·G_{bb} are expressed in logarithm scale (dB). In equations (4) the adjustment transmitter power previously estimated to reach the interference equalization are also included. The power corrections calculated above are then sent back 209, 210 to the transmit radio units 205, 206 and finally applied to the physical transmitter (typically the RF power amplifiers).

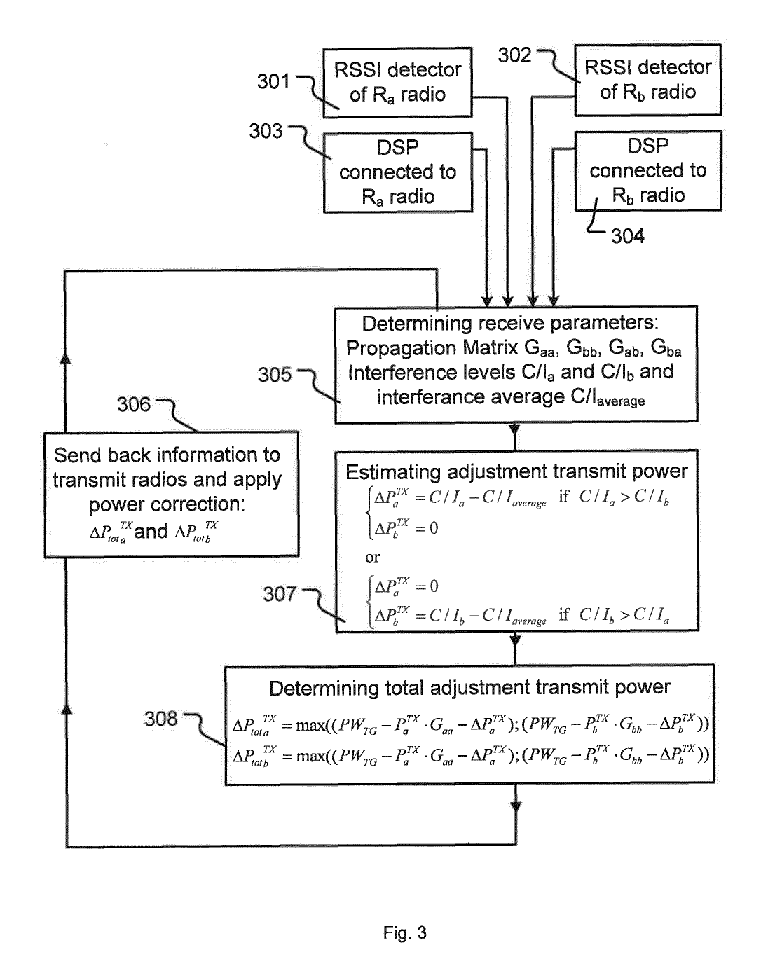

FIG. 3 shows a flowchart describing the MIMO ATPC method. To be able to perform the MIMO ATPC of the 2×2 LOS MIMO communication system the current RSSI levels 301, 302 at the two radio units Rₐ 301 and R_{b} 302 together with information from the DSPs 303, 304 are used to determine the propagation matrix 305, with the attenuations of the radio paths, and the interference levels 305. In the next step the adjustment transmit powers are determined 307 using the interference levels determined in step 305. The adjustment transmit powers are then used together with the propagation matrix and a target receiver power level to determine the total adjustment powers 308 which are sent back to the transmit radio units 306 an applied to adjust the output power of the transmit radio units, and thus performing MIMO ATPC in the 2×2 LOS MIMO communication system.

A benefit with the present invention is that it is not necessary to have any type of synchronization between the two control digital blocks 217,216. The information related to the power correction sent back to the transmit ends is smoothly applied to the power amplifiers with a constant time around tens or hundreds times faster than the complete MIMO ATPC loop response time. Thus, if the computation time of the digital control blocks 216,217 and the handshaking of the link parameters between the modems 215 occur with a refresh time that is faster than the time of the complete ATPC loop (at the state of the art around a few milliseconds), no synchronization is required.

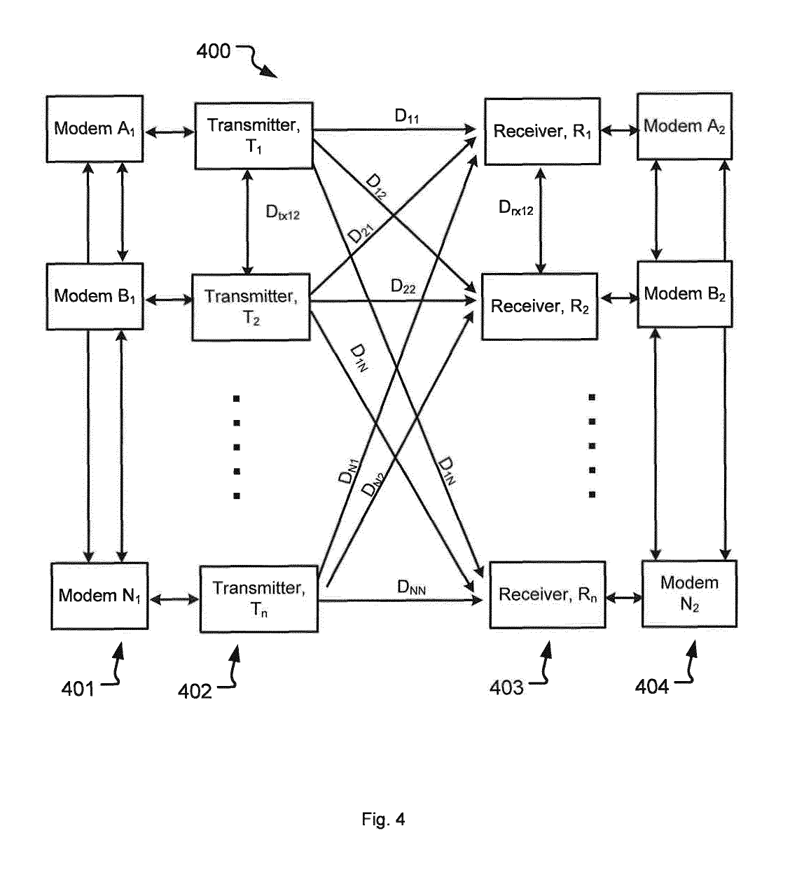

The ATPC algorithm described above can be used as a starting point for an MIMO ATPC control loop in a generic N-by-N (hereinafter N×N) LOS MIMO communication system. A block diagram of a general LOS MIMO N-by-N communication system is shown in FIG. 4. The LOS MIMO N-by-N communication system is typically comprised of N transmitter radio units 402 and N receiver radio units 403 (in the figure called T₁, T₂, . . . Tₙ and R₁, R₂, . . . Rₙ) connected to their own modems 401,404. The output transmit power transmitted by the respective radio units 402, denoted T₁, T₂ . . . Tₙ, is in the same manner as in the 2×2 case denoted P₁^{TX}, P₂^{TX} . . . , Pₙ^{TX} respectively. The total received power at the antennas of each radio unit R₁, R₂, . . . Rₙ is denoted P₁^{RX}, P₂^{RX}, . . . Pₙ^{RX}. The attenuation of the radio paths which connects transmitter Tⱼ and receiver Rᵢ are denoted Gᵢⱼ for each index i and j from 1 to N (∀i and j=1 . . . N). Equation (2) above may then be written as to defined the various interference levels at each receiver radio unit. In fact, each receiver radio unit is in the N×N case effected by interference from N−1 transmitter radio units, and thus the interference level can be expressed as shown in equation (5).

$${C}_{i} / {I}_{j} = 10 \cdot LOG ( \frac{{P}_{i}^{TX} \cdot {G}_{ij}}{{P}_{j}^{TX} \cdot {G}_{ij}} ) ∀ i = 1 … N , ∀ j = 1 … N \\ with j \neq i \qquad ( 5 )$$

In a similar way as in the 2×2 LOS MIMO case it is now possible to define the target received power of the N×N LOS MIMO communication system. PW_{TG} is the target receive power level wanted at the receiver side just across the main path, D_{NN}, without any interference contribution. Thus, PW_{TG} is the target receive power of the terms Pᵢ^{TX}·Gᵢᵢ at receiver Rᵢ for each index i from 1 to N.

As well as in the described 2×2 LOS MIMO communication system case above, the basic concept of the MIMO ATPC loop in the N×N LOS MIMO communication system case, is to perform an adjustment of the transmit power of the transmitter radio units in order to reach the best trade-off between optimum interference levels in the system while still guarantying a minimum target receive power at the receiver radio units. The MIMO ATPC method balances the interference values of the N radio paths and simultaneously converging at the wanted receiver target receive power. By knowing the interference levels at the receiver side (Cᵢ/Iⱼ) the present invention is able to calculate an adjustment of the transmit radio units power in order to balance and optimize the interference ratio values. The ‘interference balance’ operation is performed by determining (or estimating) the transmit power correction that needs to be applied to each transmitter radio unit depending on the impinging interference on the receiver radio units. Transmit power variations are obtained by identifying the path with the lowest interference by finding the maximum value among the (Cᵢ/Iⱼ) values, as described in equation (6).

Cᵢₘₐₓ/Iⱼₘₐₓ=max(Cᵢ/Iⱼ)∀i=1 . . . N,∀j=1 . . . N with j≠1 (6)

The different interference ratio levels can be considered as a function of the Tᵢₘₐₓ radio unit, then the lowest interference ratio value received at the Rᵢₘₐₓ radio unit can be expressed as in equation (7).

min[Cᵢₘₐₓ/Iₙ]_{∀n={1 . . . N}≠imax} (7)

The lowest interference ratio value received from the different N receive radio units, with an interfering signal coming from the interference generate from the Tᵢₘₐₓ radio unit, can then be expressed as in equation (8).

min└Cⱼ/Iᵢₘₐₓ┘_{∀j={1 . . . N}≠imax} (8)

Then the power variation to be applied at the Tᵢₘₐₓ radio unit can then be calculates as shown by equation (9). This power variation will equalize the interference matrix in the best way possible.

$$Δ {P}_{i ma x}^{TX} = \frac{{min [ {C}_{i ma x} / {I}_{n} ]}_{∀ n = \{ 1 … N \} \neq i ma x} + min {⌊ {C}_{j} / {I}_{i ma x} ⌋}_{∀ j = \{ 1 … N \} \neq i ma x}}{2} \qquad ( 9 )$$

The proposed MIMO ATPC method increases the powers of all transmit radio units, except the transmit corresponding to the Tᵢₘₐₓ radio unit, by an equal amount such that the most degraded link reaches the nominal received power value. Thus, the interference ratios Cᵢ/Iⱼ are maintained constant improving the reliability and availability of the link and, at the same time, increasing the robustness of the system in terms of the signal to noise ratio. The total power corrections ΔPₜₒₜᵢ^{TX} (with i≠imax) and ΔPₜₒₜᵢₘₐₓ^{TX} applied to the Tᵢ radio unit can then be expressed as shown in equation (10).

ΔPₜₒₜᵢ^{TX}|_{∀i={1 . . . N}≠imax}=max|PW_{TG}−Pₙ^{TX}·Gₙₙ|_{∀n={1 . . . N}}

ΔPₜₒₜᵢₘₐₓ^{TX}=max|PW_{TG}−Pₙ^{TX}·Gₙₙ|_{∀n={1 . . . N}}+ΔPᵢₘₐₓ^{TX} (10)

The terms Pₙ^{TX}·Gₙₙ is expressed in logarithm scale (dB). In equations (10) a max total power correction is determined based on the power variation previously estimated to reach the interference equalization is also included. The total power corrections (ΔPₜₒₜᵢ^{TX}|_{∀i={1 . . . N}≠imax}) and the max total power correction (ΔPₜₒₜᵢₘₐₓ^{TX}) determined in (10) are sent back to the transmit radio units and applied to the physical transmitter (typically the RF power amplifiers), adjusting their transmit power, and thus performing MIMO ATPC on the N×N LOS MIMO communication system.

A flowchart 500 of the N×N MIMO ATPC method is shown in FIG. 5. The DSPs 501 and the RSSI detectors 502 in each receive radio and modem will supply the ATPC loop continuously with updated parameters such as the received power 502, P₁^{RX}, P₂^{RX}, . . . Pₙ^{RX}, of each radio unit R₁, R₂, . . . Rₙ determined in the RSSI detector of each receive radio unit. In the first step of the method (503) a propagation matrix comprising each radio path's attenuation between said transmitter radio unit and said receiver radio unit is determined. The total power corrections ΔPₜₒₜᵢ^{TX} is determined 506 using the received power, the propagation matrix and a target received power, PW_{TG} which may be preset. The determined total power corrections is applied 507 to the Tᵢ transmitter radio units and thereby adjusting the transmit power of the transmit radio units. The step of determining the total power corrections 506 is preceded by a step wherein the interference level at each receiver radio unit is determined 504 based on the received power at each radio unit and the propagation matrix is determined. The power variation ΔPᵢₘₐₓ^{TX} for the Tᵢₘₐₓ radio unit is then determined 505 using said interference levels, and a max total power correction ΔPₜₒₜᵢₘₐₓ^{TX} is determined 506 using the received power, the target receive power, the propagation matrix and the power variation. The max total power correction determined in step 506 is then applied 507 to the Tᵢₘₐₓ transmitter radio unit, and thus completing the MIMO ATPC on the N×N LOS MIMO communication system.

The ATPC for a N×N microwave radio link systems in LOS MIMO configuration presented above performs an automatic transmit power control over the hop by reaching the best trade-off between the interference levels in the main radio branches and keeping the receiver power levels as close as possible to a wanted power target.

The radio link performances in a LOS MIMO configuration, both in term of robustness versus signal to noise ratio and system availability, are extremely depended to the relationship of the two interference signals levels (in the 2×2 MIMO case) present in the two main radio paths. The optimum situation, to allow the system to work in ‘best condition’, is to achieve symmetry between the two interference levels, meaning to bring the system to operate with a similar interference levels as possible. In the opposite situation, when the radio link is working in asymmetrical interference condition, the performance of the main radio path will be corrupted and/or result in that the communication link will go down. The MIMO ATPC algorithm, according to the embodiments of the present invention presented above, is in a first stage only based on the optimization of the ‘MIMO’ performance trying to reach the optimum solution given by two equal interference levels signals. In fact, the MIMO ATPC loop always corrects the ‘interference symmetry’ of the system assuring, during run time, the best radio link situation available in the LOS MIMO configuration. From a customer point of view this means that the unavailable time of the link due to asymmetrical propagation of the radio signals across the hop (equivalent to say asymmetrical interference condition as reported above) is kept to a minimum. Moreover, it also means that we get a system with good robustness in term of immunity to a low signal to noise ratio. If a classic SISO ATPC loop approach would be used instead of the presented MIMO ATCP methods it would, with a high degree of probability result in that the system would end up in a ‘dead lock’ condition where one of the interference levels would be so high that it couldn't be tolerated by the system.

After reaching the best hop condition from a LOS MIMO point of view (symmetrical interferences), the MIMO ATPC loop will provide a continuous adjustment of the transmit powers in order to reach the receiver target receive power. The adjustment is performed without changing the interference ratios but instead by moving both the transmit power of the radios in order to reach the wanted target receive power in the most degraded radio path.

The presented MIMO ATPC approach will allow the customer to minimize the outage of the link, maximize the robustness in terms of high signal to noise ratio (for instance dues natural fading in the propagation path such as rain) and at the same time avoid over power conditions. This will also have a positive impact on the OPEX cost of the site installation and maintenance (power saving), and increase the MTBF of the equipment (especially in the transmit power amplifier chain).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The foregoing has described the principles, preferred embodiments and modes of operation of the present invention. However, the invention should be regarded as illustrative rather than restrictive, and not as being limited to the particular embodiments discussed above. The different features of the various embodiments of the invention can be combined in other combinations than those explicitly described. It should therefore be appreciated that variations may be made in those embodiments by those skilled in the art without departing from the scope of the present invention as defined by the following claims.

1. A method of automatic transmit power control in a multiple-input multiple-output radio communication system having N transmitter radio units, T₁, T₂, . . . , Tₙ, and N receiver radio units, R₁, R₂, . . . , Rₙ, the method comprising:
estimating a received power, P₁^{RX}, P₂^{RX}, . . . , Pₙ^{RX}, of each receiver radio unit R₁, R₂, . . . , Rₙ;
determining a propagation matrix including each radio path's attenuation between each of said transmitter radio units and each of said receiver radio units;
determining total power corrections ΔPₜₒₜᵢ^{TX} using said received powers, said propagation matrix and a target receiver power (PW_{TG}), wherein said determining of said total power corrections includes:
determining an interference level at each receiver radio unit based on said received power at each radio unit and said propagation matrix,
determining a power variation ΔPᵢₘₐₓ^{TX} for a Tᵢₘₐₓ transmitter radio unit using said interference levels,
determining a max total power correction ΔPₜₒₜᵢₘₐₓ^{TX} using said received power, said target receiver power, said propagation matrix and said power variation; and
applying said total power corrections to said Tᵢ transmitter radio units, wherein said applying further includes applying said max total power correction to the Tᵢₘₐₓ transmitter radio unit.

2. The method according to claim 1, wherein the total power corrections ΔPₜₒₜᵢ^{TX} are determined according to
ΔPₜₒₜᵢ^{TX}|_{∀i={1 . . . N}≠imax}=max|PW_{TG}−Pₙ^{TX}·Gₙₙ|_{∀n={1N}}.

3. The method according to claim 1, wherein said target receiver power is preset.

4. The method according to claim 1, wherein said power variation is determined according to
$$Δ {P}_{i ma x}^{TX} = \frac{{min [ {C}_{i m ax} / {I}_{n} ]}_{∀ n = \{ 1 … N \} \neq i ma x} + min {⌊ {C}_{j} / {I}_{i ma x} ⌋}_{∀ j = \{ 1 … N \} \neq i ma x}}{2}$$
wherein Cᵢₘₐₓ/Iⱼₘₐₓ is a path with the lowest interference value.

5. The method according to claim 1, wherein said max total power correction ΔPₜₒₜᵢₘₐₓ^{TX} is determined according to
ΔPₜₒₜᵢₘₐₓ^{TX}=max|PW_{TG}−Pₙ^{TX}·Gₙₙ|_{∀n={1 . . . N}}+ΔPᵢₘₐₓ^{TX}.

6. A system for automatic transmit power control in a multiple-input multiple-output radio communication system, the system comprising:
R₁, R₂, . . . Rₙ receiver radio units each adapted to estimate a received power, P₁^{RX}, P₂^{RX}, . . . Pₙ^{RX};
T₁, T₂, . . . , Tₙ transmitter radio units;
at least a modem adapted to determine a propagation matrix including each radio path's attenuation between each of said transmitter radio units and each of said receiver radio units and is further adapted to determine total power corrections ΔPₜₒₜᵢ^{TX} using said received powers, said propagation matrix and a target receiver power (PW_{TG}), and said at least a modem is further adapted to:
determine an interference level at each receiver radio unit based on said received power at each radio unit and said propagation matrix,
determine a power variation ΔPᵢₘₐₓ^{TX} for a Tᵢₘₐₓ transmitter radio unit using said interference levels,
determine a max total power correction ΔPₜₒₜᵢₘₐₓ^{TX} using said received power, said target receiver power, said propagation matrix and said power variation; and
wherein said transmitter radio units are adapted to receive said total power corrections and applying said total power corrections to said Tᵢ transmitter radio units; and the Tᵢₘₐₓ transmitter radio unit is adapted to receive and to apply said max total power correction.

7. The system according to claim 6, wherein said at least a modem is adapted to determine the total power corrections ΔPₜₒₜᵢ^{TX} according to
ΔPₜₒₜᵢ^{TX}|_{∀i={1 . . . N}≠imax}=max|PW_{TG}−Pₙ^{TX}·Gₙₙ|_{∀n={1N}}.

8. The system according to claim 6, wherein said target receiver power is preset in said at least a modem.

9. The system according to claim 6, wherein said at least a modem is further adapted to determine the power variation according to
$$Δ {P}_{i m ax}^{TX} = \frac{{min [ {C}_{i ma x} / {I}_{n} ]}_{∀ n = \{ 1 … N \} \neq i m ax} + min {⌊ {C}_{j} / {I}_{i ma x} ⌋}_{∀ j = \{ 1 … N \} \neq i ma x}}{2}$$
wherein Cᵢₘₐₓ/Iⱼₘₐₓ is a path with the lowest interference value.

10. The system according to claim 6, wherein said at least a modem is further adapted to determine the max total power correction ΔPₜₒₜᵢₘₐₓ^{TX} according to
ΔPₜₒₜᵢₘₐₓ^{TX}=max|PW_{TG}−Pₙ^{TX}·Gₙₙ|_{∀n={1 . . . N}}+ΔPᵢₘₐₓ^{TX}.

11. The system according to claim 6, wherein said multiple-input multiple-output radio communication system is a microwave radio link system employing quadrature amplitude modulation in a line-of-sight configuration.
